(19) United States
(12) Patent Application Publication
(10) Pub. No.: US 2013/0194261 A1
(43) Pub. Date: Aug. 1, 2013

(54) System For Skin Treatment Analysis Using Spectral Image Data To Generate 3D RGB Model

(71) Applicants: Phillip Cummins, Livingston, NJ (US); Garrett William Vanderover, Bellerose, NY (US); Christina G. Fthenakis, Dix Hills, NY (US); Lise W. Jorgensen, Trumbull, CT (US)

(72) Inventors: Phillip Cummins, Livingston, NJ (US); Garrett William Vanderover, Bellerose, NY (US); Christina G. Fthenakis, Dix Hills, NY (US); Lise W. Jorgensen, Trumbull, CT (US)

(21) Appl. No.: 13/579,990

(22) PCT Filed: Mar. 3, 2011
(86) PCT No.: PCT/US2011/027057

§ 371 Date: Feb. 6, 2013

Related U.S. Application Data
(60) Provisional application No. 61/312,559, filed on Mar. 10, 2010.

(51) Int. Cl. G06T 17/00

(52) U.S. Cl. CPC G06T 17/00
USPC 345/420

(57) ABSTRACT

A method is provided for tracking and analyzing changing skin conditions and displaying such conditions in an RGB image format on a three dimensional virtual model to facilitate research and consumer communication. The system involves building a catalog, library or database of skin conditions in the form of datasets taken from spectral images that include the skin conditions of interest. For each spectral image dataset identifying a skin condition of interest a corresponding RGB dataset is calculated and compiled in a database. The database of calculated RGB datasets is used to diagnose skin conditions of subjects by analyzing RGB or spectral photographs of the subject. The spectral or RGB data sets can also be used to predict the effects of proposed treatments and the resulting altered skin condition can be displayed in RGB images that are readily comprehended.

### FIELD OF THE INVENTION

This invention relates to improved systems for analyzing and tracking skin conditions of a subject via photographs of the subject. In particular, it relates to an improved system and method for analyzing and tracking skin conditions via spectral and/or RGB format photographs of a subject, and simulating and/or tracking results of treatment of such skin conditions. The invention further relates to displaying such changing and treated conditions in an RGB image format on a three dimensional virtual model to facilitate research and consumer communication.

### BACKGROUND OF THE INVENTION

The use of spectral imaging for tissue analysis and diagnosis is known as disclosed, for example, in U.S. Pat. No. 5,016,173 to Kenet et al., incorporated herein in its entirety by reference. Kenet et al. discloses an apparatus and method for in vivo monitoring of visually accessible surfaces of the body, including subsurface morphology. Kenet et al. teaches the combination of multiple digital photography techniques, including multispectral and multiview and/or multiresolution photographic methods to characterize and classify surface structure components and their temporal-spacial distributions.

A problem with the prior art is that it relies primarily on spectral imaging equipment for data capture, analysis and display. This is because spectral imaging allows levels of detail and analysis that are not possible within the visible light limitations of RGB format imaging equipment and photographs.

Unfortunately, spectral imaging equipment is relatively complex in structure and use, and of limited availability, e.g., it is better suited for laboratory or clinical use by trained technicians. Accordingly, until spectral imaging equipment becomes more widely available in simpler forms, the apparatus taught by prior art references such as Kenet may not be practical for wider distribution and use, such as, for example, by consumers in a retail environment or by users in a home environment.

Similarly, by its nature, spectral image data is difficult for the untrained eye to understand, view and/or analyze. Spectral image data is typically displayed in an abstract-art-like image with color separation that is confusing at best to the untrained eye. Accordingly, even if spectral image equipment becomes more widely available in more user friendly forms, data and images produced from the equipment is unlikely to be useful to the general public at large. Accordingly, the prior art systems are not useful on a broader scale, such as in a retail environment as a marketing tool.

Accordingly, there is a need for a system that is simple but effective, i.e., that permits use in non-laboratory or non-clinical circumstances, using widely available consumer oriented image equipment such as, for example, conventional digital cameras or the digital cameras that are commonly found in telephones, computers, personal digital assistants (PDA's) or other consumer electronics devices. There is further a need for a system that produces images and data that is easy to understand, analyze and view, even for the untrained eye.

### SUMMARY OF THE INVENTION

The present invention provides a method for tracking and analyzing changing skin conditions and displaying such conditions in an RGB image format on a three dimensional virtual model to facilitate research and consumer communication. The system involves building a catalog, library or database of skin conditions in the form of datasets taken from spectral images that include the skin conditions of interest. For each spectral image dataset identifying a skin condition of interest a corresponding RGB dataset is calculated and compiled in a database. The database of calculated RGB datasets can then be used to diagnose skin conditions of subjects by, for example, analyzing RGB or spectral photographs of the subject. The spectral and/or RGB data sets can also be used to predict the effects of proposed treatments and the resulting altered skin condition can be displayed in RGB images that are readily comprehended by a larger audience than is presently possible solely with spectral images.

### DESCRIPTION OF DRAWINGS

FIG. 1 is a flow diagram showing how an RGB dataset and a spectral image dataset are used to create a virtual look up table (LUT).

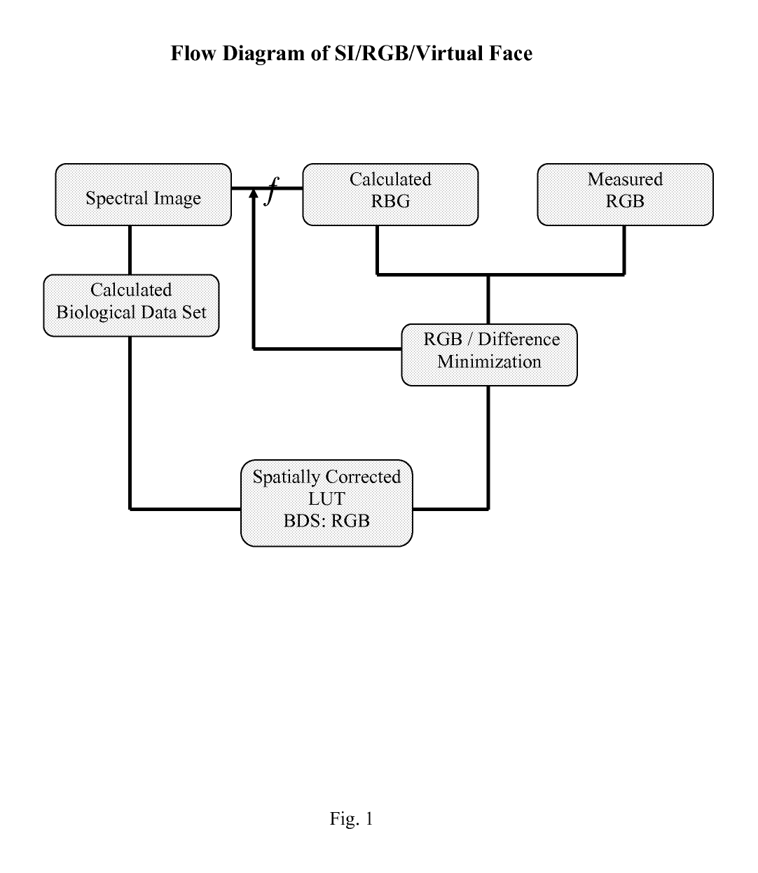

FIG. 2 is a flow diagram showing how captured and compiled information is used to analyze the skin conditions of an individual subject by capturing either spectral or RGB two dimensional photographs (“subject spectral images” or subject RGB images”) of the individual subject and comparing datasets taken from the photographs to the reference datasets in the database(s) (LUT).

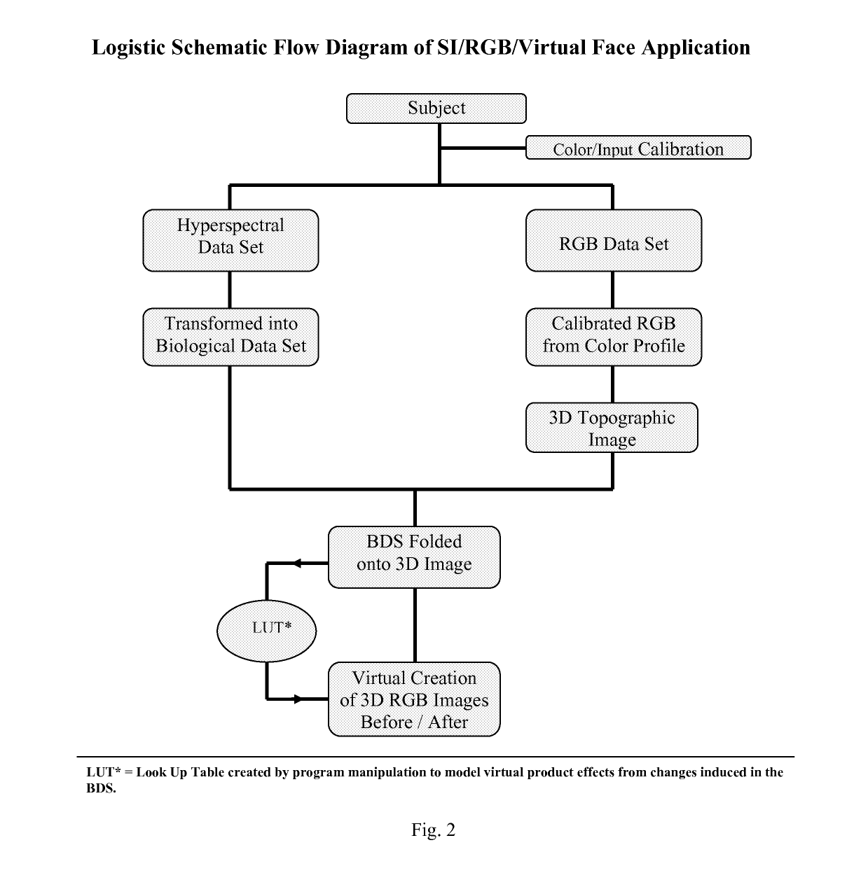

### DETAILED DESCRIPTION

Data bases are compiled using facial images captured from a large number of human subjects from a spectral camera, and a digital camera. The images are linked to specific skin conditions and are obtained under standard lighting conditions and internally calibrated.

More specifically, a plurality of two-dimensional digital spectral images (“spectral image” or “spectral images”) of human skin are captured from a variety of human subjects and stored in a database. Each spectral image defines a target area of skin (“target” or “targets”). A corresponding plurality of two-dimensional digital RGB (red, green, blue) color model images (“RGB image” or “RGB images”) are captured and stored in the same or a second database. Each of the RGB images corresponds at least in part to at least one of the spectral images defining a target. At least some of the plurality of spectral images is analyzed to identify within the respective spectral image one or more spectral image datasets. As used herein, “spectral image dataset” or “spectral image datasets” is the minimum amount of spectral image digital data required to uniquely define a condition of the skin (“skin condition”), as, for example, associated with a particular skin type, blood or melanin level, oxygen saturation, percent hemoglobin, deral scattering effect, percent water or moisture content, etc. The defined skin condition may be a skin condition not needing treatment or correction (for discussion purposes referred to herein as ‘normal’ skin conditions), or the defined skin condition may be a treatable or correctable skin condition such as, for example, dry, oily, cracked, and other treatable, correctable skin conditions. In any case, each spectral image dataset defines at least one skin condition.

Each element within each image within each database is recorded and indexed for pixel coordinates on the image, RGB value of the pixel or spectral content of the pixel, and type of skin condition at that pixel. Thus each skin condition is “mapped” in the respective image.

More specifically, each spectral image dataset is mapped to a location within the respective spectral image. The mapped location is referred to herein as the “spectral location”, i.e., the pixel coordinate location within a spectral image for a spectral image dataset. In an RGB image corresponding to the respective spectral image, a location is mapped that corresponds to each spectral location. The location in the RGB image is referred to herein as the “RGB location”, i.e., the pixel coordinate location within an RGB image that corresponds to a spectral location in a respective spectral image. For each spectral location, an RGB dataset is determined using standard functions (e.g., as disclosed in Berns, Roy. Billmeyer and Saltzman's Principles of Color Technology. Third Edition. New York, N.Y.: John Wiley & Sons, 2000. 201-203. Print., incorporated herein by reference in its entirety). As used herein, “RGB dataset” or “RGB datasets” refers to the minimum amount of digital RGB data required to uniquely identify an RGB color profile associated with that respective location. In this way the spectral image dataset is effectively correlated to an RGB dataset that corresponds to at least one known skin condition defined by said spectral image dataset.

In this way, an RGB dataset is created pixel by pixel from each spectral dataset by passing the spectral data through a conversion function with the area under each resulting curve being summed to provide the RGB dataset. The conversion function is optimized from the minimization of the differences between the measured RGB values in RGB and those values calculated from the transformation RGB of the spectral dataset.

In this way a virtual look up table (LUT) between the RGB dataset and the spectral image dataset is established which is representative across all spectral image datasets within the database. It is expected that this method of averaging will be sufficient as representation within a given skin color type is a small variation in color space. It can however be extended to averaging in such a way as to represent the continuum of skin colors types experienced.

In this way, the different skin conditions are cataloged in spectral datasets and corresponding to determinable ‘reference’ RGB datasets. The captured spectral images and corresponding captured RGB images are compiled in one or more databases in a computer storage medium, along with the spectral image datasets representing skin conditions, the spectral locations, the RGB locations and the reference RGB datasets. The reference RGB datasets may be considered ‘nonoptimized’ as they contain relatively less precise data both quantitatively and qualitatively when compared to spectral datasets for the same pixel coordinates. However, they are sufficiently optimized for subsequent use in the analysis of subject RGB image data captured by widely available consumer oriented image equipment such as, for example, conventional digital cameras or the digital cameras that are commonly found in telephones, computers, personal digital assistants (PDA's) or other consumer electronics devices.

The captured and compiled information is used to analyze the skin conditions of an individual subject by capturing either spectral or RGB two dimensional photographs (“subject spectral images” or subject RGB images”) of the individual subject and comparing datasets taken from the photographs to the reference datasets in the database(s). The resulting analysis can be used to recommend treatments for various skin conditions. The captured two dimensional images of the individual subject are also assembled in a composite on a three-dimensional frame to create an interactive, rotatable, virtual three-dimensional RGB image or model displaying the identified skin conditions, both ‘normal’ and treatable, in the locations on model corresponding to actual locations on subject. The database information is further used to generate on the three-dimensional RGB image an alteration of the displayed skin conditions resulting from application of treatments.

An advantage of the present invention is that RGB images alone can be used as the basis for the analysis of a subject. As RGB photography equipment is ubiquitous, cheaply and readily available, the images used for analysis can be taken almost anywhere, e.g., in a retail setting at counter, at a solon, at home, or on-the-go with a camera in a personal digital assistant or cell phone. There is no need for expensive, specialized spectral imaging cameras in laboratory settings.

Another advantage of the present invention is that it uses real time data to display resulting images that are “realistic” or “actual” projections of results from a treatment—i.e., virtual renderings of what the results will be. This is in contrast to current systems that merely estimate the results without underlying actual data.

Another advantage of the present invention is that either RGB or spectral images of a subject can be used as the basis for the analysis of the subject.

Once the database and LUT of spectral data sets correlated to RGB data sets is established, the system requires three basic steps: 1) take an RGB picture, 2) normalize (standardize) the RGB image via standard ICC profiling software to calibrate the color, intensity, etc. across various devices, and 3) compare the normalized data sets of the RGB image to the LUT to determine corresponding spectral image data sets, and in turn, the skin conditions associated with the spectral image datasets.

What is claimed is:

1. A method for tracking and analyzing changing skin conditions and displaying such conditions in an RGB image format on a three dimensional virtual model to facilitate research and consumer communication, the method comprising the steps of:
capturing a plurality of digital spectral images of human skin, each spectral image defining a target;
capturing a plurality of digital RGB images, each RGB image corresponding at least in part to at least one of the spectral images defining a target;
analyzing at least some of the plurality of spectral images to identify within the respective spectral image one or more spectral image datasets, each spectral image dataset defining at least one skin condition;
mapping within the respective spectral image one or more spectral locations for each of the one or more spectral image datasets;
mapping within each RGB image corresponding to the respective spectral image one or more RGB locations corresponding to the respective one or more spectral locations of the each of the one or more spectral image datasets;
calibrating an RGB dataset corresponding to the spectral image dataset associated with that respective spectral location and mapping it to the RGB location such that the at least one known skin condition defined by said spectral image dataset can be reproduced in RGB format via the corresponding RGB image dataset;
compiling a database of said plurality of spectral images, said spectral image datasets, said corresponding skin conditions, said spectral locations, said plurality of RGB images, said RGB datasets and said RGB locations;
capturing one or more digital RGB images, each digital image capturing an area of skin of a subject;
analyzing each digital RGB image to locate any predetermined RGB datasets from the database;
mapping the locations of the RGB color datasets within each RGB color image; and
overlaying the RGB color image onto a three dimensional virtual frame to create a virtual three dimensional model of the subject showing realistic skin conditions in locations on models corresponding to actual locations on subject.

2. The system of claim 1 wherein at least some of the plurality of digital spectral images are two-dimensional images.

3. The system of claim 1 wherein at least some of the plurality of digital spectral images are three-dimensional images.

4. The system of claim 1 wherein at least some of the plurality of digital RGB images are two-dimensional images.

5. The system of claim 1 wherein at least some of the plurality of digital RGB images are three-dimensional images

6. A system for use in analyzing human skin condition using a two-dimensional spectral image, the system comprising:
a computer including a processor and a memory for storing instructions for the processor to perform a method including the steps of:
capturing at least one RGB image of a subject's face, wherein the at least one captured image exhibits at least one skin condition;
processing data representing the RGB image to enable a skin condition analysis via comparison of the RGB image data to correlated spectral image data;
processing the original data representing the two-dimensional image to enable displaying the original image in a three-dimensional format;
selecting a beauty product for altering the at least one skin condition;
altering the data representing the two-dimensional image to simulate the altered skin condition; and
displaying the altered data representing the simulated skin condition in one of an altered two-dimensional image or an altered three-dimensional image including the simulated altered skin condition.
